(19) United States
(12) Patent Application Publication
(10) Pub. No.: US 2019/0364520 A1
(43) Pub. Date: Nov. 28, 2019

(54) ADAPTING BETWEEN SYNCHRONOUS AND ASYNCHRONOUS OPERATIONS BASED ON NUMEROLOGY

(71) Applicant: Telefonaktiebolaget LM Ericsson (publ), Stockholm (SE)

(72) Inventors: Muhammad KAZMI, SUNDBYBERG (SE); Mattias BERGSTRÖM, SOLLENTUNA (SE); Iana SIOMINA, TÄBY (SE)

(21) Appl. No.: 16/332,251

(22) PCT Filed: Sep. 28, 2017
(86) PCT No.: PCT/IB2017/055974

§ 371 Date: Mar. 11, 2019

Related U.S. Application Data
(60) Provisional application No. 62/402,369, filed on Sep. 30, 2016.

(51) Int. Cl. H04W 56/00; H04W 8/22

(52) U.S. Cl. CPC H04W 56/00; H04W 8/22

(57) ABSTRACT

A method, wireless device, and network node configured to determine a synchronization status for the wireless device based on a first numerology and a second numerology, In one embodiment, a method performed by a wireless device for determining a synchronization status for the wireless device based on a first numerology and a second numerology is provided. The method includes estimating a time difference between receipt of a first downlink signal received from a first network node, and receipt of a second downlink signal received from a second network node, obtaining a first downlink threshold based on the first numerology and the second numerology, and determining the synchronization status of the wireless device based on a relationship between the estimated time difference and the first downlink threshold.

### FIELD

The present disclosure relates to wireless communications, and in particular, to a method, wireless device and network node for adaptation between synchronous and asynchronous operations in a wireless network based on numerology.

### BACKGROUND

New Radio (NR) Architecture

NR (also known as 5G or Next Generation) architecture is being discussed in Third Generation Partnership Project (3GPP) and the current concept is illustrated in FIG. 1, where eNB denotes a Long Term Evolution (LTE) eNodeB 1, gNB denotes a NR base station (BS) 2 (one NR BS may correspond to one or more transmission/reception points), and the lines between the nodes (an evolved packet core (EPC) 3 and next generation core (NextGen core) 4) illustrate the corresponding interfaces which are under discussion in 3GPP. Further, FIGS. 2A-2D illustrate deployment scenarios with NR BS which are discussed in 3GPP. For example, FIG. 2A shows a non-centralized configuration where a core 5 serves separately located NR BS 2 and an LTE eNB 1. FIG. 2B shows a configuration where a NR BS 2 is collocated with an eNB 1. FIG. 2C is a configuration where the NR BS 2 is divided into an upper layer 2-A and lower layers 2-B. FIG. 2D is a configuration where cores 5-A, 5-B and 5-C are operated by different operators such that different operators share gNBs 2.

NR Numerology

For LTE, the term “numerology” includes, e.g., the following elements: frame duration, subframe or transition time interval (TTI) duration, slot duration, subcarrier spacing, number of subcarriers per resource block (RB), number of RBs within the bandwidth (different numerologies may result in different numbers of RBs within the same bandwidth).

The exact values for the numerology elements in different radio access technologies (RATs) are typically driven by performance targets, e.g., performance requirements impose constraints on usable subcarrier spacing sizes, e.g., the maximum acceptable phase noise and the slow decay of the spectrum (impacting filtering complexity and guardband sizes) set the minimum subcarrier bandwidth for a given carder frequency, and the required cyclic prefix sets the maximum subcarrier bandwidth for a given carrier frequency.

However, the numerology used so far in the existing RATs is rather static and typically can be trivially derived by the wireless device (e.g., User Equipment (UE)), e.g., by one-to-one mapping to RAT, frequency band, service type (e.g., multimedia broadcast multicast services (MBMS)), etc.

In LTE downlink which is orthogonal frequency-division multiplexing (OFDM)-based, the subcarrier spacing is 15 kHz for normal cycle prefix (CP) and 15 kHz and 7.5 kHz (i.e., the reduced carrier spacing) for extended CP, where the latter is allowed only for MBMS-dedicated carriers.

The support of multiple numerologies has been agreed for NR, which can be multiplexed in the frequency and/or time domain for the same or different wireless devices.

In NR, which is to be based on OFDM, multiple numerologies will be supported for general operation. A scaling approach (based on a scaling factor 2\hat{ }n, n=1, 2, . . . ) is considered for deriving subcarrier spacing candidates for NR: 15 kHz, 30 kHz, 60 kHz, etc. The numerology-specific subframe durations can then be determined in ms based on the subcarrier spacing: subcarrier spacing of (2^{m}*15) kHz gives exactly ½^{m} ms.

Subcarrier spacings of up to 960 kHz are currently being discussed for NR (the highest discussed values correspond to millimeter-wave based technologies). It was also agreed that multiplexing different numerologies within a same NR carrier bandwidth is supported, and frequency division multiplexing (FDM) and/or time division multiplexing (TDM) can be considered. It was further agreed that multiple frequency/time portions using different numerologies share a synchronization signal, where the synchronization signal refers to the signal itself and the time-frequency resource used to transmit the synchronization signal. Yet another agreement is that the numerology used can be selected independently of the frequency band although it is assumed that a very low subcarrier spacing will not be used at very high carrier frequencies. In FIG. 3, some candidate carrier spacings are illustrated with respect to the frequency and cell range. In Table 1 below, further details are provided on corresponding time durations for some candidate carrier spacings.

In multicarrier or carrier aggregation (CA) operation, the wireless device is able to receive and/or transmit data to more than one serving cell. The term carrier aggregation (CA) is also called (e.g., interchangeably called) “multi-carrier system,” “multi-cell operation,” “multi-carrier operation,” “multi-carrier” transmission and/or reception. In CA, one of the component carriers (CCs) is the primary component carrier (PCC) or simply primary carrier or even anchor carrier. The remaining ones are called secondary component carriers (SCC) or simply secondary carriers or even supplementary carriers. The serving cell is interchangeably called a primary cell (PCell) or primary serving cell (PSC). Similarly, the secondary serving cell is interchangeably called a secondary cell (SCell) or secondary serving cell (SSC).

In Dual Connectivity (DC) operation, the wireless device can be served by at least two nodes; one called the master eNB (MeNB) and another called the secondary eNB (SeNB). Generally, in multiple connectivity (aka multi-connectivity) operation, the wireless device can be served by two or more nodes, e.g., MeNB, SeNB1, SeNB2 and so on. The wireless device is configured with PCC from both MeNB and SeNB. The PCell from MeNB and SeNB are called as PCell and PSCell respectively. The PCell and PSCell operate the wireless device typically independently. The wireless device is also configured with one or more SCCs from each of MeNB and SeNB. The corresponding secondary serving cells served by MeNB and SeNB are called SCells. The wireless device in DC typically has separate transmitter (TX)/receiver (RX) for each of the connections with MeNB and SeNB. This allows the MeNB and SeNB to independently configure the wireless device with one or more procedures e.g. radio link monitoring (RLM), Discontinuous Reception (DRX) cycle etc. on their PCell and PSCell respectively. The methods and embodiments are applicable to both CA, DC and Multi-Connectivity (MC).

The term “signaling” used herein may comprise any of: high-layer signaling (e.g., via Radio Resource Control (RRC) or the like), lower-layer signaling (e.g., via a physical control channel or a broadcast channel), or a combination thereof. The signaling may be implicit or explicit. The signaling may further be unicast, multicast or broadcast. The signaling may also be directly to another node or via a third node.

The term time resource used herein may correspond to any type of physical resource or radio resource expressed in terms of length of time. Examples of time resources are: symbol, time slot, subframe, radio frame, transmission time interval (TTI), interleaving time, etc.

The term “flexible numerology” used herein may refer, e.g., to any one or more of: subcarrier spacing, number of subcarriers per RB, number of RBs within the bandwidth, etc. which can be configured in a flexible way and may be changed dynamically.

The term “radio measurement” used herein may refer to any measurement performed on radio signals. Radio measurements can be absolute or relative. Radio measurements can be e.g. intra-frequency, inter-frequency, CA, etc. Radio measurements can be unidirectional (e.g., downlink (DL) or uplink (UL)) or bidirectional (e.g., round-trip time (RTT), Rx-Tx, etc.). Some examples of radio measurements: timing measurements (e.g., time of arrival (TOA), timing advance, RTT, Reference Signal Time Difference (RSTD), SSTD, Rx-Tx, propagation delay, etc.), angle measurements (e.g., angle of arrival), power-based measurements (e.g., received signal power, reference signal received power (RSRP), received signal quality, reference signal received quality (RSRQ), signal-to-interference-plus-noise ratio (SINR), signal-to-noise ratio (SNR), channel state information (CSI), channel quality information (CQI), precoding matrix indicator (PMI), interference power, total interference plus noise, received signal strength indicator (RSSI), noise power, etc.), cell detection or identification, beam detection or beam identification, system information reading, radio link monitoring (RLM), etc.

Multicarrier Operation

In carrier aggregation (CA), the terminal is configured with a PCC (or cell or Serving cell) which is referred to as the Primary Cell (PCell). The PCell is particularly important e.g. due to the fact that the control signaling is signaled on this cell etc. Also, the wireless device performs monitoring of the radio quality on the PCell. A CA capable terminal can, as explained above, also be configured with additional carriers (or cells or serving cells) which are referred to as Secondary Cells (SCells).

In dual connectivity (DC), a wireless device in an RRC_CONNECTED state is configured with a Master Cell Group (MCG) and a Secondary Cell Group (SCG). Cell Group (CG) is a group of serving cells associated with either the MeNB or the SeNB, respectively. The MCG and SCG are defined as follows: MCG is a group of serving cells associated with the MeNB, comprising the PCell and, optionally, one or more SCells. SCG is a group of serving cells associated with the SeNB comprising the pSCell (Primary SCell) and, optionally, one or more SCells.

The serving cell management is performed by means of media access control (MAC) commands to control (de)configuration of SCell(s) (aka SCell addition), (de)activation of SCell(s), and setting up and releasing PSCell in DC. The PCell is always activated, while SCell can be activated or deactivated.

Multiple Tags

A wireless device configured with CA, is configured with at least one Timing Advance Group (TAG) which is a pTAG containing PCell. The pTAG may also contain one or more SCells.

The wireless device capable of supporting multiple timing advances may also be configured with one or more serving cells with uplink in one or more sTAGs, in addition to pTAG.

The wireless device capable of supporting dual connectivity shall be configured with one pTAG and may also be configured with one psTAG. The pTAG shall contain the PCell and may also contain one SCell, if configured. The psTAG shall contain the PSCell and may also contain one SCell, if configured. In pTAG, the wireless device shall use the PCell as the reference cell for deriving the wireless device transmit timing for pTAG, and in psTAG, the wireless device shall use the PSCell as the reference cell for deriving the wireless device transmit timing for psTAG.

Cells in the same TAG can share the same reference timing. Furthermore, if at least one serving cell of the TAG is uplink time aligned, all serving cells belonging to the same group may use this timing adjustment value.

The TAGs are configured by the eNodeB. Each sTAG has associated sTAG ID and a time alignment timer (TAT). The TAT starts when a serving cell of the TA group performs random access and is thereby assigned its first TA value. The TAT is then restarted each time the TA value used by the TA group is updated, e.g., upon reception of a TA command (TAC). A SCell is considered uplink time aligned when the associated TAT is running and it may then, if activated, transmit on the wireless device. When the TAT expires, the serving cells associated with that TAT may not perform any wireless device transmission except for random access request.

Synchronized and Unsynchronized Dual Connectivity Operation

In DC, the handling of the maximum received timing difference (Δt) of the signals from MeNB and SeNB received at the wireless device depends on wireless device architecture. This gives rise to two cases of dual connectivity (DC) operation with respect to the wireless device synchronization status or level namely: synchronized DC operation and unsynchronized DC operation. The synchronized DC operation and unsynchronized DC operation are also interchangeably called synchronous and asynchronous DC.

The synchronized operation herein means that the wireless device can perform DC operation provided the received time difference (Δt) between the signals received at the wireless device from the CCs belonging to the MCG and SCG are within a certain threshold e.g. ±33 μs. As an example, the synchronized operation herein means that the received time difference (Δt) between the signals received at the wireless device from the subframe boundaries of the CCs belonging to the MCG and SCG are within a certain threshold e.g. ±33 μs.

The unsynchronized operation herein means that the wireless device can perform DC operation regardless of the received time difference (Δt) between the signals received at the wireless device from the CCs belonging to the MCG and SCG i.e. for any value of Δt. As an example, the unsynchronized operation herein means that the received time difference (Δt) between the signals received at the wireless device from the subframe boundaries of the CCs belonging to the MCG and SCG can be any value e.g. more than ±33 μs, any value up to ±0.5 ms etc.

Furthermore, the wireless device is also capable of handling a maximum uplink transmission timing difference between PCell and PSCell of at least
35.21 μs if the wireless device is capable of synchronous dual connectivity and
Up to 500 μs if the wireless device is capable of asynchronous dual connectivity

Maximum receive timing difference (Δt) at the wireless device includes the following components:

(1) Relative propagation delay, which is expressed as the difference of propagation delay between MeNB and SeNB;

(2) Tx timing difference due to synchronization levels between antenna connectors of MeNB and SeNB; and

(3) Delay due to multipath propagation of radio signals from each of the eNBs.

The wireless device signals its capability to the network node indicating whether the wireless device is capable of synchronized and/or unsynchronized dual connectivity operation. The capability information is associated with each band or band combination supported by the wireless device for dual connectivity operation e.g. the wireless device may indicate it supports synchronized and unsynchronized DC operations for frequency band combinations: band 1+band 3 and band 7+band 8, respectively. Based on this received wireless device capability information the network node can determine whether the wireless device should be configured in synchronized or unsynchronized DC operation for a particular band or band combination.

### SUMMARY

In NR, different numerologies can be used in different time resources of the same link or on different links involved in an operation. Examples of operations are multicarrier operation, positioning measurements performed over two or more links or cells e.g. received time difference. The multi-connectivity operation of the wireless device can be synchronous or asynchronous. Also, the positioning measurements can be performed on pair of cells which can be synchronous or asynchronous. However, the impact of different numerology on such operations (e.g. multi-connectivity operation) is undefined. In particular, the impact on the synchronization status of the wireless device under different possible numerologies is unknown. Due to these limitations and undefined principles, operations such as the multi-connectivity operation in the NR and/or positioning cannot be performed or at least the performance of these operations will be severely degraded.

Certain embodiments of aspects of the present disclosure may provide one or more technical advantages, including:
The multi-connectivity operation involving different numerologies is enhanced.
Synchronization status of the wireless device under multi-connectivity operation involving different numerologies is well defined.

Certain embodiments may have some, all or none of the above advantages. Other advantages will be apparent to persons of ordinary skill in the art.

Some embodiments include a method performed by a wireless device for determining a synchronization status for the wireless device based on a first numerology and a second numerology. The method includes estimating a time difference between receipt of a first downlink signal received from a first network node and receipt of a second downlink signal received from a second network node. The method further includes obtaining a first downlink threshold based on the first numerology and the second numerology. The method also includes determining the synchronization status of the wireless device based on a comparison between the estimated time difference and the first downlink threshold.

According to another aspect, some embodiments include a wireless device configured to determine a synchronization status for the wireless device based on a first numerology and a second numerology. The wireless device includes a communications interface. The wireless device also includes processing circuitry configured to estimate a time difference between receipt of a first downlink signal received from a first network node, and receipt of a second downlink signal received from a second network node. The processing circuitry is also configured to obtain a first downlink threshold based on the first numerology and the second numerology. The processing circuitry is also configured to determine the synchronization status of the wireless device based on a comparison between the estimated time difference and the first downlink threshold.

In some embodiments, a method performed by a network node for determining a synchronization status for a wireless device based on a first numerology and a second numerology is provided. The method includes obtaining, from the wireless device, an estimated time difference between receipt, by the wireless device of a first downlink signal received from a first network node, and receipt, by the wireless device of a second downlink signal received from a second network node. The method further includes obtaining a first downlink threshold based on the first numerology and the second numerology. The method also includes determining the synchronization status of the wireless device based on a comparison between the estimated time difference and the first downlink threshold. In some embodiments, a network node configured to determine a synchronization status for a wireless device based on a first numerology and a second numerology is provided. The network node includes a communications interface configured to: obtain, from the wireless device, an estimated time difference between receipt, by the wireless device of a first downlink signal received from a first network node, and receipt, by the wireless device of a second downlink signal received from a second network node; and obtain a first downlink threshold based on the first numerology and the second numerology. The network node also includes processing circuitry configured to determine the synchronization status of the wireless device based on a comparison between the estimated time difference and the first downlink threshold.

In some embodiments, a method performed by a wireless device for determining a synchronization status for the wireless device based on a first numerology and a second numerology. The method includes estimating a time difference between a transmission time of a first uplink signal transmitted by the wireless device and a transmission time of a second uplink signal transmitted by the wireless device. The method also includes obtaining a first uplink threshold based on the first numerology and the second numerology. The method further includes determining the synchronization status of the wireless device based on a comparison between the estimated time difference and the first uplink threshold.

In some embodiments, a wireless device configured to determine a synchronization status for the wireless device based on a first numerology and a second numerology is provided. The method includes processing circuitry configured to estimate a time difference between transmission of a first uplink signal transmitted by the wireless device and transmission of a second uplink signal transmitted by the wireless device. The processing circuitry is also configured to obtain a first uplink threshold based on the first numerology and the second numerology and determine the synchronization status of the wireless device based on a comparison between the estimated time difference and the first uplink threshold.

In some embodiments, a method performed by a network node for determining a synchronization status for a wireless device based on a first numerology and a second numerology is provided. The method includes obtaining, from the wireless device, an estimated time difference between transmission of a first uplink signal and transmission of a second uplink signal. The method also includes obtaining a first uplink threshold based on the first numerology and the second numerology. The method also includes determining the synchronization status of the wireless device based on a comparison between the estimated time difference and the first uplink threshold.

In some embodiments, a network node configured to determine a synchronization status for a wireless device based on a first numerology and a second numerology is provided. The network node includes processing circuitry configured to obtain, from the wireless device, an estimated time difference between transmission of a first uplink signal and transmission of a second uplink signal. The processing circuitry is further configured to obtain a first uplink threshold based on the first numerology and the second numerology, and determine the synchronization status of the wireless device based on a comparison between the estimated time difference and the first uplink threshold.

In some embodiments, a method performed by a wireless device for determining a synchronization status for the wireless device based on a first numerology and a second numerology defined for data transmission is provided. The method includes estimating a transmission time difference between a first signal and a second signal exchanged between the wireless device and a first network node and a second network node, respectively. The method also includes obtaining a threshold based on the first numerology and the second numerology. The method also includes determining the synchronization status of the wireless device based on a comparison between the estimated transmission time difference and the threshold.

In some embodiments, a wireless device for determining a synchronization status for the wireless device based on a first numerology and a second numerology defined for data transmission is provided. The wireless device includes processing circuitry configured to estimate a transmission time difference between a first signal and a second signal exchanged between the wireless device and a first network node and a second network node, respectively. The processing circuitry is also configured to obtain a threshold based on the first numerology and the second numerology, and determine the synchronization status of the wireless device based on a comparison between the estimated transmission time difference and the threshold.

In some embodiments, a method performed by a network node for determining a synchronization status for a wireless device based on a first numerology and a second numerology defined for data transmission is provided. The method includes obtaining, from the wireless device, an estimated transmission time difference between a first signal and a second signal exchanged between the wireless device and a first network node and a second network node respectively, obtaining a threshold based on the first numerology and the second numerology and determining the synchronization status of the wireless device based on a comparison between the estimated transmission time difference and the threshold.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is an illustration of an NR architecture;

FIGS. 2-2D are an illustration of deployment scenarios with NR base stations;

FIG. 3 is an illustration of example subcarrier spacing candidate configurations for NR;

FIG. 4 illustrates an exemplary wireless device for determining a synchronization status for the wireless device based on a first numerology and a second numerology in accordance with the principles described herein;

FIG. 5 is a flowchart of an exemplary process performed by a wireless device for determining a synchronization status for the wireless device based on a first numerology and a second numerology in accordance with the principles described herein;

FIG. 6 illustrates an exemplary network node for determining a synchronization status for the wireless device based on a first numerology and a second numerology in accordance with the principles described herein;

FIG. 7 is a flowchart of an exemplary process performed by a network node for determining a synchronization status for the wireless device based on a first numerology and a second numerology in accordance with the principles described herein;

FIG. 8 illustrates another exemplary wireless device for determining a synchronization status for the wireless device based on a first numerology and a second numerology in accordance with the principles described herein;

FIG. 9 illustrates another exemplary network node for determining a synchronization status for the wireless device based on a first numerology and a second numerology in accordance with the principles described herein;

FIG. 10 is a flowchart of another exemplary process performed by a wireless device for determining a synchronization status for the wireless device based on a first numerology and a second numerology;

FIG. 11 is a flowchart of another exemplary process performed by a network node for determining a synchronization status for a wireless device based on a first numerology and a second numerology;

FIG. 12 is a flowchart of another exemplary process performed by a wireless device for determining a synchronization status for the wireless device based on a first numerology and a second numerology; and

FIG. 13 is a flowchart of an exemplary process performed by a network node for determining a synchronization status of a wireless device.

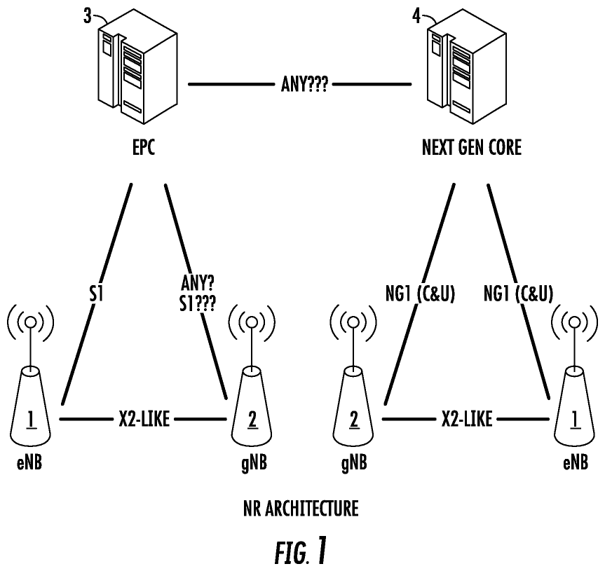

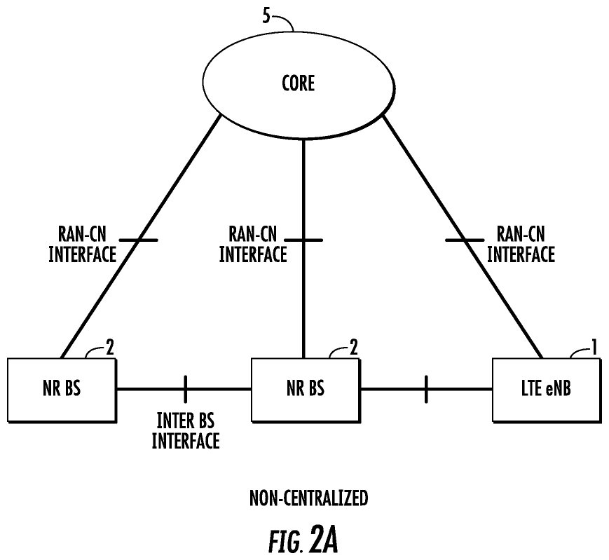

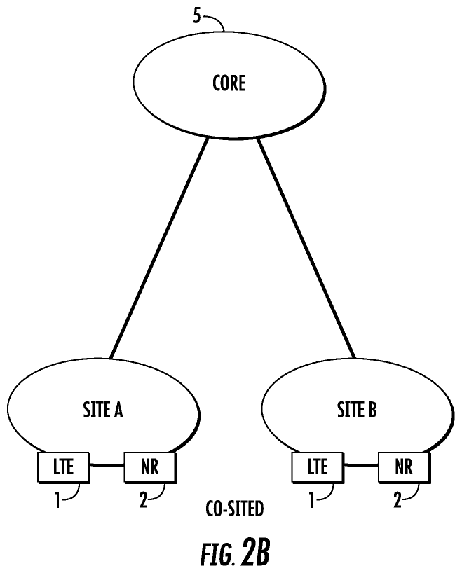

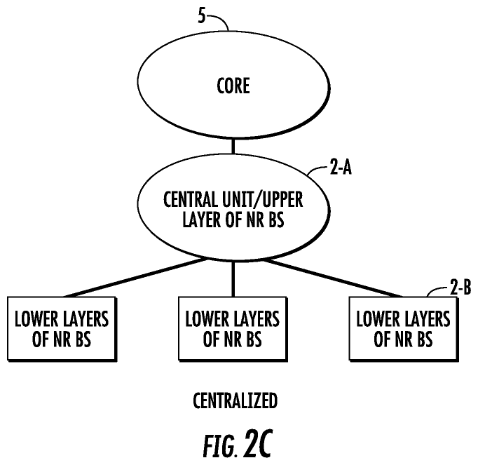

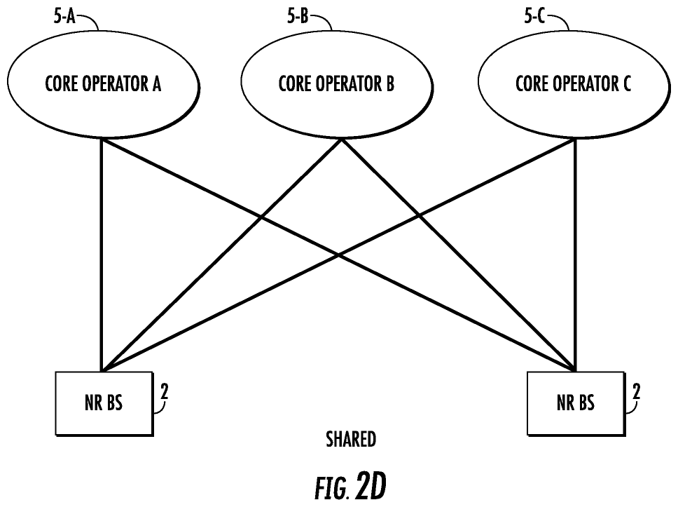

### DETAILED DESCRIPTION

Note that although terminology from the third generation partnership project (3GPP), i.e., long term evolution (LTE) is used in this disclosure as an example, this should not be seen as limiting the scope of the disclosure to only the aforementioned system. Other wireless systems, including NR (i.e., 5G), wideband code division multiple access (WCDMA), WiMax, ultra mobile broadband (UMB) and global system for mobile communications (GSM), may also benefit from exploiting the concepts and methods covered within this disclosure.

Also note that terminology such as eNodeB and wireless device should be considered non-limiting and does in particular not imply a certain hierarchical relation between the two; in general “eNodeB” could be considered as device 1 and “wireless device” device 2, and these two devices communicate with each other over some radio channel. Also, while the disclosure focuses on wireless transmissions in the downlink, embodiments are equally applicable in the uplink.

The term “wireless device” used herein may refer to any type of wireless device communicating with a network node and/or with another wireless device in a cellular or mobile communication system. Examples of a wireless device are user equipment (UE), target device, device to device (D2D) wireless device, machine type wireless device or wireless device capable of machine to machine (M2M) communication, a sensor equipped with UE, PDA, iPAD, Tablet, mobile terminals, smart phone, laptop embedded equipped (LEE), laptop mounted equipment (LME), USB dongles, computer premises equipment (CPE), etc.

The term “network node” used herein may refer to a radio network node or another network node, e.g., a core network node, MSC, MME, O&M, OSS, SON, positioning node (e.g. E-SMLC), MDT node, etc.

The term “network node” or “radio network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3^{rd} party node, a node external to the current network), nodes in distributed antenna system (DAS) etc. The network node may also comprise test equipment. The term “radio node” used herein may be used to also denote a wireless device such as a UE or a radio network node.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Before describing in detail exemplary embodiments, it is noted that the embodiments reside primarily in combinations of apparatus components and processing steps related to adaptation between synchronous and asynchronous operations in a wireless network based on numerology. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements.

In some embodiments, the present disclosure provides a wireless device that indicates to another node, information about the wireless device capability related to the support of synchronous and/or asynchronous operation (e.g. multi-connectivity, carrier aggregation, positioning etc.). In one embodiment, this step is an optional step in the process. In a next step, the wireless device estimates a receive time difference (ΔTr) between a first downlink signal (DLS1) received at the wireless device from a first network node (NW1) and a second downlink signal (DLS2) received at the wireless device from a second network node (NW2). In one embodiment, NW1 and NW2 may be the same. In another embodiment, NW1 and NW2 may be different.

In a next step, the wireless device determines at least one first numerology (N1) and at least one second numerology (N2) used for operating DLS1 and DLS2 respectively. In a next step, the wireless device obtains a first downlink threshold (G1) based on the determined N1 and N2. In a next step, the wireless device determines a synchronization status of the wireless device based on a relation between ΔTr and G1. Optionally, the wireless device may use the determined synchronization status of the wireless device for one or more operational tasks.

The following describes each of the steps presented above in greater detail. In the first (optional) step, the wireless device may indicate to another node (e.g., a network node, e.g., radio network node, core network node, positioning node, etc.) information about the wireless device's capability related to the support of synchronous and/or asynchronous multi-connectivity. The indicated wireless device capability may further include capability of the wireless device to operate synchronous and/or asynchronous multi-connectivity under the flexible numerology scenario. The capability may be sent upon a request from another node (i.e., a network node such as an eNB) or in an unsolicited way, e.g., upon a triggering event, condition, or in response to receiving a message from another node, etc.

In the next step, the wireless device estimates a time difference (ΔTr) between a first downlink signal (DLS1) received at the wireless device from a first network node (NW1) and a second downlink signal (DLS2) received at the wireless device from a second network node (NW2). The DLS1 and DLS2 may be received in a first cell (cell1) and a second cell (cell2). Cell1 and cell2 are operated by NW1 and NW2 respectively. Cell1 and cell2 may also be serving cells of the wireless device. In one example, NW1 and NW2 are the same node. In another example, NW1 and NW2 are different nodes and may be co-sited, co-located or non-collocated. The estimation of ΔTr may be performed over an estimation time period (Td), which may include one or multiple time resources (e.g. one subframe or plurality of subframes). The estimation of ΔTr may further include one or a plurality of samples or snapshots obtained by the wireless device within Td.

The term estimation herein may interchangeably be called a calculation, measurement or determination. Similarly, the estimation time period may interchangeably be called a measurement time period, calculation time period, etc.

The estimation of ΔTr may be performed between boundaries of specific time resources. The specific time resources may be, e.g., one or more of
a certain type (e.g., subframe);
determined based on a pre-defined rule while accounting for the used numerology (e.g., between a time resource associated with DLS1 and the closest time resource with a number or ID meeting a condition [e.g. an even number or mod(ID,n)=0 where n is an integer e.g. n=2] associated with DLS2 when the subcarrier spacing for DLS1 is smaller than that for DLS2); and
determined based on an indication or message received from another node, etc.

The time resources (e.g., subframes or slots) may be of the same absolute length (but e.g. different time resource granularity within the subframes, due to different numerologies) or different absolute lengths.

For example, ΔTr may be estimated by the wireless device between the start of the DL subframes of NW1 and NW2 transmitting DLS1 and DLS2 respectively. In another example ΔTr may be estimated by the wireless device between the start of the DL frames of NW1 and NW2 transmitting DLS1 and DLS2 respectively.

The wireless device may further estimate a transmit time difference (ΔTt) between a first uplink signal (ULS1) transmitted by the wireless device in a first cell (cell1) operated by a first network node (NW1) and a second uplink signal (DLS2) transmitted by the wireless device in a second cell (cell2) operated by a second network node (NW2). The ULS1 and ULS2 may be transmitted in a first cell (cell1) and a second cell (cell2). In another example ULS1 and ULS2 may be transmitted by the wireless device in another set of cells, a third cell (cell3) and a fourth cell (cell4). Cell3 and cell4 may also be operated by NW1 and NW2 respectively. Cell3 and cell4 may also be serving cells of the wireless device. The value of ΔTt may be estimated between the starting boundaries of time resources (e.g. slot or subframe etc.) belonging to cell3 and cell4 respectively. The value of ΔTt may also be called a time difference between TAGs i.e. between TAG1 and TAG2 which contains cell3 and cell4 respectively.

The estimation of ΔTt may be performed over an estimation time period (Tu), which may include one or multiple time resources (e.g. one subframe or plurality of subframes). The estimation of ΔTt may further include one or a plurality of samples or snapshots obtained by the wireless device within Tu.

Cell1 and cell2 may be operated using carrier frequency #1 (F1) and carrier frequency #2 (F2) respectively.

Cell1 and cell2 may also be operated using carrier frequency #1 (F1) and carrier frequency #2 (F2) respectively in the DL and using carrier frequency #3 (F3) and carrier frequency #4 (F4) respectively.

In one exemplary implementation, F1 and F2 may be the same. In another exemplary implementation F1 and F2 may be different.

In one exemplary implementation, F3 and F4 may be the same. In another exemplary implementation F3 and F4 may be different.

The DLS1 and DLS2 may be transmitted by NW1 and NW2 respectively using numerology #1 (N1) and numerology #2 (N2) respectively.

The ULS1 and ULS2 may also be transmitted by the wireless device using numerology #1 (N1) and numerology #2 (N2) respectively.

In yet another example, ULS1 and ULS2 may be transmitted by the wireless device using numerology #3 (N3) and numerology #4 (N4) respectively.

In one exemplary implementation, N1 and N2 may be the same. In another exemplary implementation N1 and N2 may be different.

Also in one exemplary implementation, N3 and N4 may be the same. In another exemplary implementation, N3 and N4 may be different.

In a next step, the wireless device may determine information related to at least one first numerology (N1) and at least one second numerology (N2) used for operating DLS1 and DLS2 respectively. The wireless device may further determine information related to a plurality of numerologies used for transmitting DLS1 in the same cell or link e.g. different numerologies used in different time resources in the same cell. The wireless device may further determine information related to a plurality of numerologies used for transmitting DLS2 in the same cell or link e.g. different numerologies used in different time resources in the same cell. The wireless device may further determine information related to at least a third numerology (N3) and at least a fourth numerology (N4) used for operating ULS1 and ULS2 respectively. The wireless device may determine the numerologies based on one or more of stored information in the wireless device, indication received from a network node, radio measurements performed by the wireless device etc. The information related to a numerology may include, e.g., subcarrier spacing, time resource length, CP length, etc.

In a next step, the wireless device may determine at least a first downlink threshold (G1) based on the determined information about N1 and N2. The threshold G1 defines a boundary between synchronous and asynchronous operations of the wireless device with respect to cell1 and cell2. In some embodiments, N1 and N2 may be the same i.e. N1=N2.

G1=f(N1,N2) (1)

The wireless device may further determine a second downlink threshold (G2) based on the determined information about N1 and N2. The threshold G2 defines a maximum receive time difference that the wireless device can handle, e.g., a magnitude of the maximum ΔTr under asynchronous operation of the wireless device.

G2=f(N1,N2) (2)

Examples of the functions are: a certain fraction (e.g., half) of the smallest time unit of the same type among the two numerologies.

In the above, when two or more numerologies are used by at least one of the NW1 and NW2, N1 and/or N2 may be selected from the plurality or pluralities of numerologies used by NW1 and/or NW2 based on a pre-defined rule, e.g., N1 and N2, corresponding to the numerologies with the largest subcarrier spacings in NW1 and NW2, respectively. The same principles may apply for N3 and N4.

Examples of magnitude of G1 and G2 as a function of N1 and N2 used in cell1 and cell2 respectively are shown in Table 1 below.

Table 1: Magnitude of thresholds, G1 and G2, as a function of numerology used in downlink of cell1 and downlink of cell2. The values of X1, Y1 and Z1 correspond to the magnitude of the receive time difference that the UE can handle under synchronous operation for different combinations of numerologies used in DL of cell1 and DL of cell2. The values of X2, Y2 and Z2 correspond to the magnitude of the receive time difference that the UE can handle under asynchronous operation for different combinations of numerologies used in DL of cell1 and DL of cell2.

TABLE 1

| | Numerology used | Numerology used | | |
|---|---|---|---|---|
| No. | in DL of cell1 | in DL of cell2 | G1 | G2 |
| 1 | N1 | N1 | X1 | X2 |
| 2 | N2 | N2 | Y1 | Y2 |
| 3 | N1 | N2 | Z1 | Z2 |
| 4 | N2 | N1 | Z1 | 72 |

Specific examples of the magnitude of G1 and G2 as a function of subcarrier spacings used in cell1 and cell2 respectively are shown in Table 2 below. As shown in Table 2, the larger subcarrier spacings used in the cells results in smaller values of G1 and G2. This is because larger subcarrier spacing leads to short time resource duration (e.g. slot, subframe etc.). The value of ΔTr is estimated between boundaries of time resources (e.g. between slots) leading to smaller maximum value of G1 or G2 if the duration of the time resource (e.g. slot duration) is also smaller.

Table 2: Magnitude of thresholds, G1 and G2, as a function of subcarrier used in DL of cell1 and DL of cell2

TABLE 2

| | Subcarrier spacing | Subcarrier spacing used | | |
|---|---|---|---|---|
| No. | used in DL of cell1 | in DL of cell2 | G1 | G2 |
| 1 | 15 KHz | 15 KHz | 33 μs | 500 μs |
| 2 | 30 KHz | 30 KHz | 20 μs | 250 μs |
| 3 | 15 KHz | 30 KHz | 30 μs | 250 μs |
| 4 | 30 KHz | 15 KHz | 30 μs | 250 μs |
| 5 | 60 KHz | 60 KHz | 10 μs | 125 μs |
| 6 | 60 KHz | 15 KHz | 30 μs | 125 μs |

The wireless device may further determine a first uplink threshold (H1) based on the determined information about N3 and N4 used in wireless device of cell1 and cell2 respectively. In some embodiments, N3 and N4 may be N1 and N2 respectively. In some embodiments, N3 and N4 may be the same, i.e., N3=N4.

The threshold H1 defines a maximum value of uplink transmit time difference (ΔTt) between a first TA group (TAG1) and a second TA group (TAG2) for synchronous operation of the wireless device with respect to cell1 and cell2 in the uplink. Cell1 and cell2 belong to TAG1 and TAG2 respectively. The ΔTt is also known as the maximum uplink transmission timing difference between cell1 and cell2, e.g., between PCell and PSCell.

H1=f(N3,N4) (3)

The wireless device may further determine a second uplink threshold (H2) based on the determined information about N3 and N4. The threshold H2 defines a maximum value of uplink transmit time difference between a first TA group (TAG1) and a second TA group (TAG2) for asynchronous operation of the wireless device with respect to cell1 and cell2, e.g., magnitude of the maximum ΔTt under asynchronous operation of the wireless device

H2=f(N3,N4) (4)

Examples of magnitude of H1 and H2 as function of N3 and N4 used in the wireless device of cell1 and UL of cell2 respectively are shown in Table 3 below.

Table 3: Magnitude of thresholds, H1 and H2, as a function of numerology used in uplink of cell1 and uplink of cell2. The values of A1, B1 and C1 correspond to the magnitude of the uplink transmit time difference between the TAGs that the UE can handle under synchronous operation for different combinations of numerologies used in DL of cell1 and DL of cell2. The values of A2, B2 and C2 correspond to the magnitude of the uplink transmit time difference between the TAGs that the UE can handle under asynchronous operation for different combinations of numerologies used in DL of cell1 and DL of cell2.

TABLE 3

| | Numerology used | Numerology used | | |
|---|---|---|---|---|
| No. | in UL of cell1 | in a of cell2 | H1 | H2 |
| 1 | N3 | N3 | A1 | A2 |
| 2 | N4 | N4 | B1 | B2 |
| 3 | N3 | N4 | C1 | C2 |
| 4 | N4 | N3 | C1 | C2 |

Specific examples of magnitude of H1 and H2 as a function of subcarrier spacings used by the wireless device for UL transmission in cell1 and for UL transmission in cell2 respectively are shown in Table 4 below. As shown in Table 4, the larger subcarrier spacings used in the cells results in smaller values of H1 and H2. The value of ΔTt is estimated between boundaries of time resources (e.g. between slots) leading to smaller maximum value of H1 or H2 if the duration of the time resource (e.g. slot duration) is also smaller.

Table 4: Magnitude of thresholds, H1 and H2, as a function of subcarriers used by the wireless device for UL transmission in cell1 and for UL transmission in cell2 TABLE 4

TABLE 4

| | Subcarrier spacing | Subcarrier spacing | | |
|---|---|---|---|---|
| No. | used in UL of cell1 | used in UL of cell2 | H1 | H2 |
| 1 | 15 KHz | 15 KHz | 35.21 μs | 500 μs |
| 2 | 30 KHz | 30 KHz | 25 μs | 250 μs |
| 3 | 15 KHz | 30 KHz | 30 μs | 250 μs |
| 4 | 30 KHz | 15 KHz | 30 μs | 250 μs |
| 5 | 60 KHz | 60 KHz | 15 μs | 125 μs |
| 6 | 60 KHz | 15 KHz | 30 μs | 125 μs |

The wireless device can determine any of the threshold parameters G1, G2, H1 and H2 based on one or more of the following mechanisms:
Pre-defined rule e.g. pre-defined mapping tables 1, 2, 3, 4;
Information received from a node, e.g., from another wireless device and/or from a network node;
History or statistics;
Recently used values, e.g., recent values stored in the memory of the wireless device.

In another step, the wireless device may compare the estimated value of ΔTr with the determined value of at least G1 and based on this comparison the wireless device determines the synchronization status of the wireless device operation with respect to cell1 and cell2. The synchronization status may indicate whether the wireless device is in synchronous state or in asynchronous state with respect to cell1 and cell2. For example, the wireless device may determine that:
the wireless device is operating in synchronous mode if the magnitude of ΔTr is not larger than the magnitude of G1,
Otherwise (i.e. ΔTr>G1) the wireless device is operating in asynchronous mode.

If the wireless device is determined to be operating in asynchronous mode, then the wireless device may further ensure that the magnitude of the maximum value of ΔTt does not exceed G2.

If the wireless device operates in synchronous mode as determined above, then the wireless device may further compare the estimated value of ΔTt with the determined value of at least H1 to ensure that the wireless device is able to handle the maximum possible value of ΔTt under synchronous operation.

If the wireless device operates in asynchronous mode as determined above, then the wireless device may further compare the estimated value of ΔTt with the determined value of at least H2 to ensure that the wireless device is able to handle the maximum possible value of ΔTt under asynchronous operation.

In another step, which may be an optional step for the wireless device, the wireless device uses the determined synchronization status of the wireless device for one or more operational tasks. Examples of such operational tasks are:
Reception of signals e.g. demodulation;
Transmission of signals e.g. ACK/NACK, CSI, etc.;
Radio measurements;
Selection and application of power control scheme, etc.;
Transmitting the results of ΔTr and/or ΔTt to another wireless device;
Transmitting the results of ΔTr and/or ΔTt to a network node e.g. serving network node, core network node, positioning node, etc.;
Indicating the synchronization status of the wireless device to another node or another wireless device.

In some embodiments, a network node performs a method that includes obtaining information about wireless device capability related to the support of synchronous and/or asynchronous multi-connectivity. This is an optional step performed by the network node. In another step, the network node receives a receive time difference (ΔTr), where the ΔTr is estimated by the wireless device between a first downlink signal (DLS1) received at the wireless device from a first network node (NW1) and a second downlink signal (DLS2) received at the wireless device from a second network node (NW2). In a next step, the network node determines at least one first numerology (N1) and at least one second numerology (N2) used for operating DLS1 and DLS2 respectively, and, in a next step, obtains a first downlink threshold (G1) based on the determined N1 and N2. In another step, the network node determines a synchronization status of the wireless device based on a relation between ΔTr and G1, such as a comparison between ΔTr and G1. In another step, which is an optional step, the network node uses the determined synchronization status of the wireless device for one or more operational tasks.

The network node can be any of: a first network node (NW1), a second network node (NW2), any other radio network node (e.g. neighbor of NW1 and/or NW2) core network node etc.

The steps taken at the network node outlined above, are now discussed in greater detail.

In one step, the network node may receive from a wireless device information about the wireless devices' capability related to the support of synchronous and/or asynchronous multi-connectivity. The indicated wireless device's capability may further include the capability of the wireless device to operate synchronous and/or asynchronous multi-connectivity under the flexible numerology scenario. The network node may receive the capability information from the wireless device upon request or in an unsolicited way, e.g., upon a triggering event, condition, receiving a message from another node, etc.

In another step, the network node may obtain a receive time difference (ΔTr), which is estimated by the wireless device between a first downlink signal (DLS1) received at the wireless device from a first network node (NW1) and a second downlink signal (DLS2) received at the wireless device from a second network node (NW2).

The network node may further obtain a transmit time difference (ΔTt), estimated by the wireless device between a first uplink signal (ULS1) transmitted by the wireless device in cell3 and a second uplink signal (ULS2) transmitted by the wireless device in cell4. The estimation of ΔTr and ΔTt by the wireless device is described above in reference to the functions of the wireless device.

The network node may obtain the values of ΔTr and ΔTt based on one or more of the following:
Indication or report or measurement results received from the wireless device;
Indication or report or measurement results received from another node e.g. another radio network node, core network node;
Historical data or statistics.

In another step, the network node may determine information about a first numerology (N1) and a second numerology (N2) used for operating DLS1 and DLS2 respectively. The network node may further determine information related to a plurality of numerologies used for operating DLS1 in the same cell or link e.g. different numerologies used in different time resources in the same cell. The network node may further determine information related to a plurality of numerologies used for operating DLS2 in the same cell or link e.g. different numerologies used in different time resources in the same cell. The network node may further determine information about at least one third numerology (N3) and at least one fourth numerology (N4) used for operating ULS1 and ULS2 respectively.

The network node may determine the numerologies based on configuration information sent to the wireless device by the network node or another node e.g. NW1, NW2, etc.

In another step, the network node may determine at least a first downlink threshold (G1) based on the determined N1 and N2 used in the DL of cell1 and DL of cell2 respectively. The network node may further determine a second downlink threshold (G2) based on the determined N1 and N2 used in the DL of cell1 and DL cell2 respectively.

The network node may determine at least a first uplink threshold (H1) based on the determined N3 and N4 used in the wireless device of cell1 and the wireless device of cell2 respectively. The network node may further determine a second uplink threshold (H2) based on the determined N3 and N4 used in the wireless device of cell1 and the wireless device cell2 respectively.

The network node may determine any of the threshold parameters G1, G2, H1 and H2 based on one or more of the following mechanisms:
Pre-defined rule e.g. pre-defined mapping Tables 1, 2, 3, 4 as discussed above;
Information received from another node e.g. from another network node;
History or statistics i.e. values used in the past;
Recently used values e.g. recent values stored in the memory of the network node.

In another step, the network node may determine the synchronization status of the wireless device based on a relation between the obtained value of ΔTt and the determined value of G1. The network node may further determine whether the wireless device is operating in synchronous mode or asynchronous mode based on the comparison between the obtained value of ΔTt and the determined value of G2.

The network node may also determine whether the wireless device is able to operate with the determined maximum allowed value of ΔTt for the synchronous mode if the wireless device is capable of synchronous mode of operation with respect to cell1 and cell2. The network node may further determine whether the wireless device is able to operate with the determined maximum allowed value of ΔTt for the asynchronous mode if the wireless device is capable of asynchronous mode of operation with respect to cell1 and cell2.

If the wireless device operates in synchronous mode, then the network node may further compare the estimated value of ΔTt with the determined value of at least H1 to determine whether the wireless device is able to handle the maximum possible value of ΔTt under synchronous operation.

If the wireless device operates in asynchronous mode, then the network node may further compare the estimated value of ΔTt with the determined value of at least H2 to determine whether the wireless device is able to handle the maximum possible value of ΔTt under asynchronous operation.

In another step, which is optional for the network node, the network node uses the determined synchronization status of the wireless device for one or more operational tasks. Examples of operational tasks are:
Reception of signals from the wireless device e.g. demodulation;
Transmission of signals to the wireless device;
Scheduling of signals in UL and/or DL at the wireless device;
Radio measurements;
Timing advance estimation;
Adaptation of the configuration of measurement gaps;
Adaptation of the DRX configuration used for the wireless device;
Adaptation of measurement configuration sent to the wireless device;
Configuration of timing advance group e.g. cell1 in TAG1 and cell2 in TAG;
Selection and configuration of power control scheme etc.;
Transmitting the results of ΔTr and/or ΔTt to another network node e.g. neighboring network node, core network node, positioning node etc.

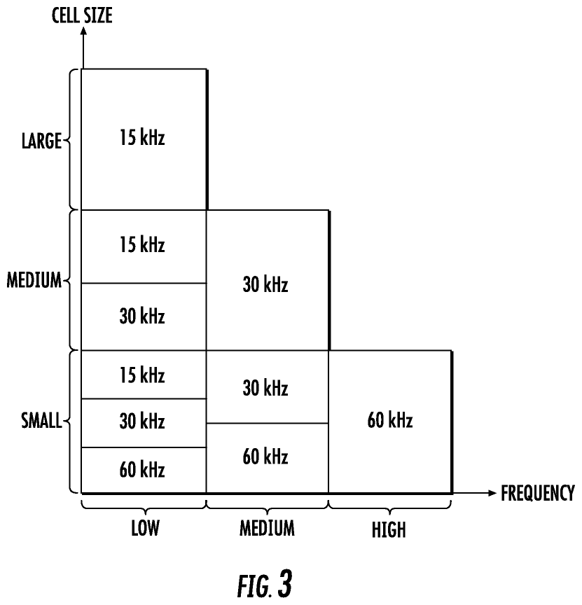

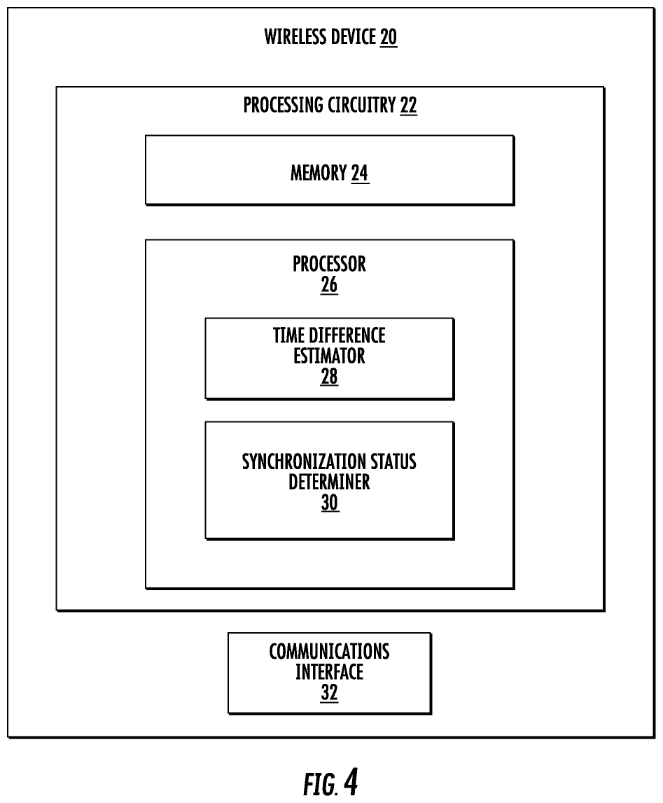

FIG. 4 is an exemplary wireless device 20 for determining a synchronization status for the wireless device 20 based on a first numerology and a second numerology. In one embodiment, wireless device includes processing circuitry 22, which includes memory 24 in communication with one or more processors 26. One or more processors 26 includes a time difference estimator 28 and a synchronization status determiner 30. Wireless device 20 also includes communications interface 32. Memory 24 includes instructions that, when executed by one or more processors 26, configure the one or more processors 26, and, specifically, time difference estimator 28, to estimate a time difference between receipt of a first downlink signal received from a first network node, and receipt of a second downlink signal received from a second network node. One or more processors 26 is further configured to obtain a first downlink threshold based on the first numerology and the second numerology. One or more processors 26, and, specifically, synchronization status determiner 30, is configured to determine the synchronization status of wireless device 20 based on a relationship between the estimated time difference and the first downlink threshold. In addition to a traditional one or more processors and memory, processing circuitry 22 may include integrated circuitry for processing and/or control, e.g., one or more processors and/or one or more processor cores and/or FPGAs (Field Programmable Gate Array) and/or ASICs (Application Specific Integrated Circuitry).

Processing circuitry 22 may include and/or be connected to and/or be configured for accessing (e.g., writing to and/or reading from) memory 24, which may comprise any kind of volatile and/or non-volatile memory, e.g., cache and/or buffer memory and/or RAM (Random Access Memory) and/or ROM (Read-Only Memory) and/or optical memory and/or EPROM (Erasable Programmable Read-Only Memory). Such memory 24 may be configured to store code executable by control circuitry and/or other data, e.g., data pertaining to communication, e.g., configuration and/or address data of nodes, etc. Processing circuitry 22 may be configured to control any of the methods described herein and/or to cause such methods to be performed, e.g., by one or more processors 26. Corresponding instructions may be stored in the memory 24, which may be readable and/or readably connected to the processing circuitry 22. In other words, processing circuitry 22 may include a controller, which may comprise a microprocessor and/or microcontroller and/or FPGA (Field-Programmable Gate Array) device and/or ASIC (Application Specific Integrated Circuit) device. It may be considered that processing circuitry 22 includes or may be connected or connectable to memory, which may be configured to be accessible for reading and/or writing by the controller and/or processing circuitry 22.

FIG. 5 is a flowchart of an exemplary process in wireless device 20 for determining a synchronization status for wireless device 20 based on a first numerology and a second numerology. Such a process may be performed, for example, by processing circuitry 22 in which, in one embodiment, memory 24 stores executable program code that, when executed by one or more processors 26, causes the processing circuitry 22 to perform the functions described herein. The process optionally includes indicating, via the communications interface 32, to another node information about a capability of a wireless device related to support of at least one of synchronous and asynchronous multi-connectivity (Block S100). The process includes estimating, by one or more processors 26, and, specifically, by time difference estimator 28 of wireless device 20, a time difference between receipt of a first downlink signal received from a first network node, and receipt of a second downlink signal received from a second network node (Block S110). The process further includes obtaining, by one or more processors 26, a first downlink threshold based on the first numerology and the second numerology (Block S120), and determining, by one or more processors 26, and, specifically, by synchronization status determiner 30 of wireless device 20, the synchronization status of wireless device 20 based on a relationship between the estimated time difference and the first downlink threshold (Block 8130). The process optionally includes using, via the processor 26, the determined synchronization status of the wireless device for at least one operational task (Block S140).

In one embodiment, the first numerology is used for operating the first downlink signal and the second numerology is used for operating the second downlink signal. In one embodiment, the first network node and the second network node are the same. In one embodiment, the first network node and the second network node are different.

In one embodiment, the at least one operational task comprises at least one of demodulation of received signals, transmission of signals, radio measurements, at least one of selection and application of a power control scheme, transmission of at least one of the estimated time difference and an uplink transmit time difference to another wireless device, transmission of at least one of the estimated time difference and the uplink transmit time difference to another network node, and indicating the synchronization status of wireless device 20 to at least one of another network node or another wireless device. In another embodiment, the method may further include estimating, by one or more processors 26 of wireless device 20, a transmit time difference between a first uplink signal transmitted by wireless device 20 in a first cell operated by the first network node and a second uplink signal transmitted by wireless device 20 in a second cell operated by the second network node.

It should be noted that the one or more processors 26 in combination with the communications interface 32 of FIG. 4 are configured to perform the method of FIG. 5 and the above embodiments.

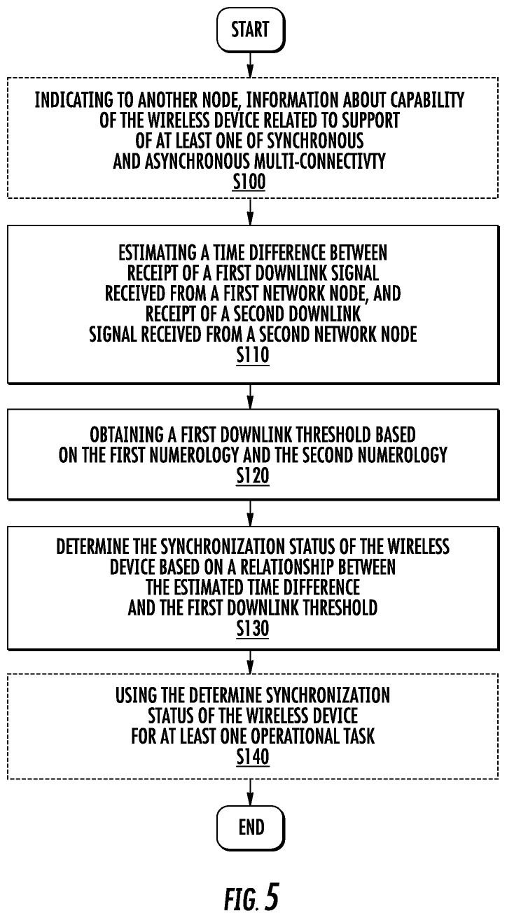

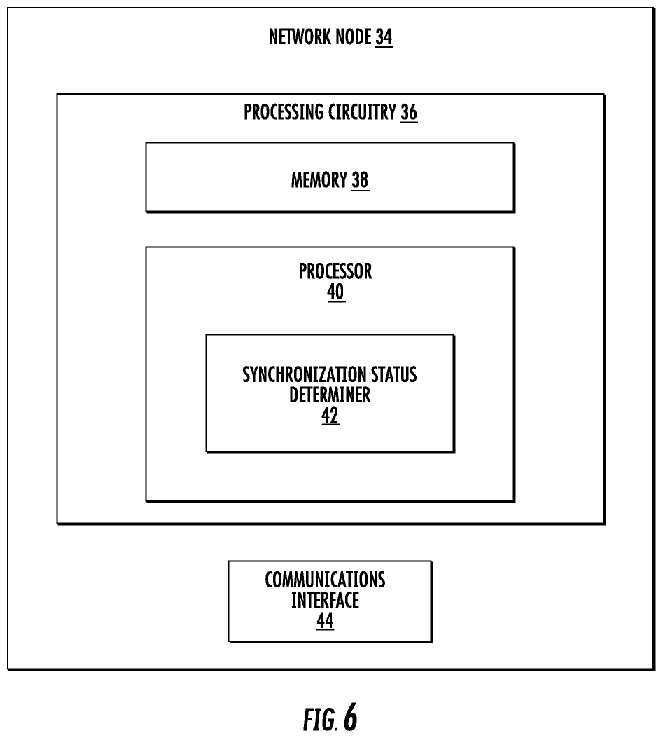

FIG. 6 is an exemplary network node 34 for determining a synchronization status for wireless device 20 based on a first numerology and a second numerology. Network node 34 includes processing circuitry 36, which includes memory 38 in communication with one or more processors 40. One or more processors 40 includes a synchronization status determiner 42. Network node 34 also includes a communications interface 44. Communications interface 44 is configured to obtain, from wireless device 20, an estimated time difference between receipt, by wireless device 20 of a first downlink signal received from a first network node, and receipt, by wireless device 20 of a second downlink signal received from a second network node. Communications interface 44 is also configured to obtain a first downlink threshold based on the first numerology and the second numerology. Memory 38 includes instructions that, when executed by one or more processors 40, configure one or more processors 40, and, specifically, synchronization status determiner 42, to determine the synchronization status of wireless device 20 based on a relationship between the estimated time difference and the first downlink threshold. In addition to a traditional processor and memory, processing circuitry 36 may include integrated circuitry for processing and/or control, e.g., one or more processors and/or one or more processor cores and/or FPGAs (Field Programmable Gate Array) and/or ASICs (Application Specific Integrated Circuitry).

Processing circuitry 36 may include and/or be connected to and/or be configured for accessing (e.g., writing to and/or reading from) memory 38, which may comprise any kind of volatile and/or non-volatile memory, e.g., cache and/or buffer memory and/or RAM (Random Access Memory) and/or ROM (Read-Only Memory) and/or optical memory and/or EPROM (Erasable Programmable Read-Only Memory). Such memory 38 may be configured to store code executable by control circuitry and/or other data, e.g., data pertaining to communication, e.g., configuration and/or address data of nodes, etc. Processing circuitry 36 may be configured to control any of the methods described herein and/or to cause such methods to be performed, e.g., by one or more processors 36. Corresponding instructions may be stored in the memory 38, which may be readable and/or readably connected to the processing circuitry 36. In other words, processing circuitry 36 may include a controller, which may comprise a microprocessor and/or microcontroller and/or FPGA (Field-Programmable Gate Array) device and/or ASIC (Application Specific Integrated Circuit) device. It may be considered that processing circuitry 36 includes or may be connected or connectable to memory, which may be configured to be accessible for reading and/or writing by the controller and/or processing circuitry 36.

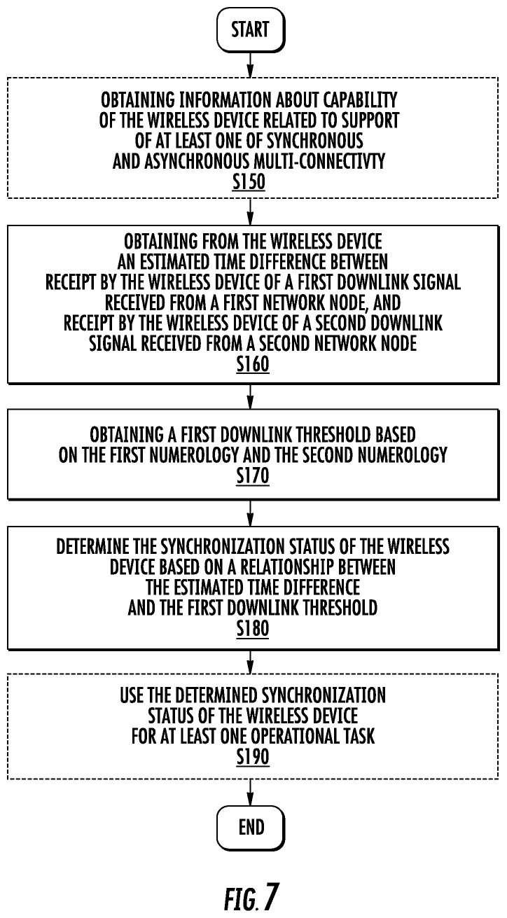

FIG. 7 is a flowchart of an exemplary process in network node 34 for determining a synchronization status for wireless device 20 based on a first numerology and a second numerology. Such a process may be performed, for example, by processing circuitry 36 in which, in one embodiment, memory 38 stores executable program code that, when executed by one or more processors 40, causes the processing circuitry 36 to perform the functions described herein. The process optionally includes obtaining information about the capability of wireless device 20 related to support of at least one of synchronous and asynchronous multi-connectivity (Block S150). This step may be performed by communications interface 44 of network node 34. In one embodiment, the information is received from wireless device 20 in response to a request for the information from network node 34. The process includes obtaining, by communications interface 44, from wireless device 20, an estimated time difference between receipt, by wireless device 20 of a first downlink signal received from a first network node, and receipt, by wireless device 20 of a second downlink signal received from a second network node (Block 8160). The process further includes obtaining, by communications interface 44, a first downlink threshold based on the first numerology and the second numerology (Block S170). The process further includes determining, by one or more processors 40, and, specifically, synchronization status determiner 42 of network node 34, the synchronization status of wireless device 20 based on a relationship between the estimated time difference and the first downlink threshold (Block S180). In one embodiment, the process optionally includes the step of using the determined synchronization status of wireless device 20 for at least one operational task (Block S190). This step may be performed by one or more processors 40 of network node 34.

In one embodiment, the first numerology is used for operating the first downlink signal and the second numerology is used for operating the second downlink signal. In one embodiment, the first network node and the second network node are the same. In one embodiment, the first network node and the second network node are different.

In one embodiment, the at least one operational task comprises at least one of reception of signal from wireless device 20, transmission of signals to wireless device 20, scheduling of at least one of uplink and downlink signals, radio measurements, timing advance estimation, adaptation of configuration of measurement gaps, adaptation of the DRX configuration used for wireless device 20, adaptation of measurement configuration sent to wireless device 20, configuration of a timing advance group, at least one of selection and configuration of a power control scheme, and transmission of at least one of the estimated time difference and an uplink transmit time difference to another network node. In one embodiment, the process further includes obtaining, at network node 34, a transmit time difference, estimated by wireless device 20, between a first uplink signal transmitted by wireless device in a first cell and a second uplink signal transmitted by wireless device 20 in a second cell. This step may be performed by communications interface 44 of network node 34.

It should be noted that the one or more processors 40 in combination of the communications interface 44 of FIG. 6 are configured to carry out the method of FIG. 7 and the above embodiments.

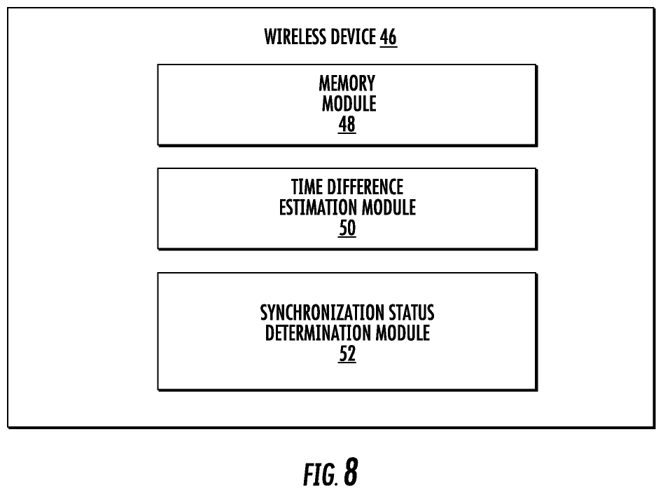

FIG. 8 another exemplary wireless device 46 for determining a synchronization status for wireless device 46 based on a first numerology and a second numerology. Wireless device 46 includes a memory module 48, a time difference estimation module 50, and a synchronization status determination module 52. Time difference estimation module 50 is configured to estimate a time difference between receipt of a first downlink signal received from a first network node, and receipt of a second downlink signal received from a second network node. Synchronization status determination module 52 is configured to obtain a first downlink threshold based on the first numerology and the second numerology and determine the synchronization status of wireless device 46 based on a relationship between the estimated time difference and the first downlink threshold.

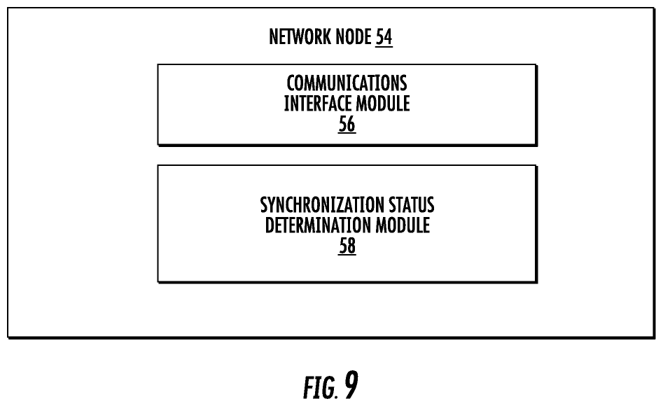

FIG. 9 is another exemplary network node 54 for determining a synchronization status for wireless device 46 based on a first numerology and a second numerology. Network node 54 includes a communications interface module 56 configured to obtain, from wireless device 46, an estimated time difference between receipt, by wireless device 46 of a first downlink signal received from a first network node, and receipt, by wireless device 46 of a second downlink signal received from a second network node, and obtain a first downlink threshold based on the first numerology and the second numerology. Network node 54 also includes a synchronization status determination module 58 configured to determine the synchronization status of wireless device 46 based on a relationship between the estimated time difference and the first downlink threshold.

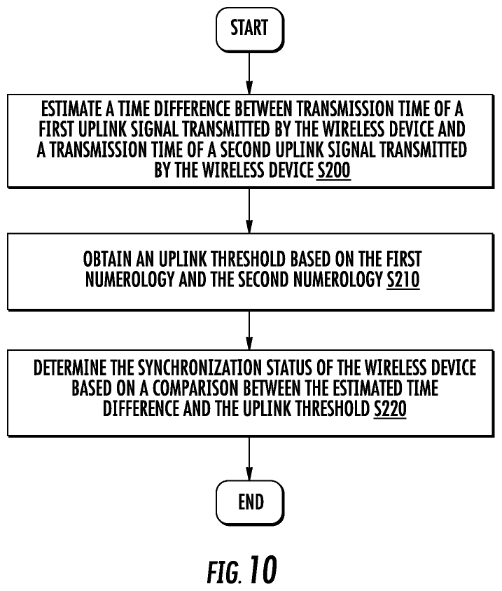

FIG. 10 is a flowchart of an exemplary process performed by a wireless device for determining a synchronization status for the wireless device based on a first numerology and a second numerology. The process includes estimating a time difference between a transmission time of a first uplink signal transmitted by the wireless device and a transmission time of a second uplink signal transmitted by the wireless device (block S200), The process further includes obtaining an uplink threshold based on the first numerology and the second numerology (block S210). The process also includes determining the synchronization status of the wireless device based on a comparison between the estimated time difference and the first uplink threshold.

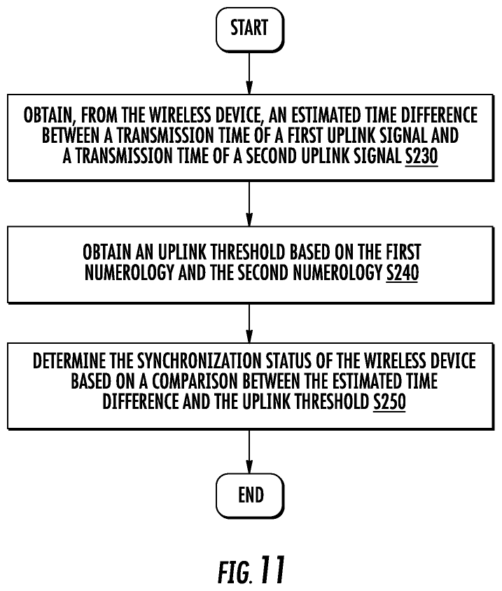

FIG. 11 is a flowchart of an exemplary process performed by a network node for determining a synchronization status for a wireless device based on a first numerology and a second numerology. The process includes obtaining, from the wireless device, an estimated time difference between a transmission time of a first uplink signal and a transmission time of a second uplink signal (block S230). The process further includes obtaining an uplink threshold based on the first numerology and the second numerology (block S240). The process also includes determining the synchronization status of the wireless device based on a comparison between the estimated time difference and the first uplink threshold (block S250).

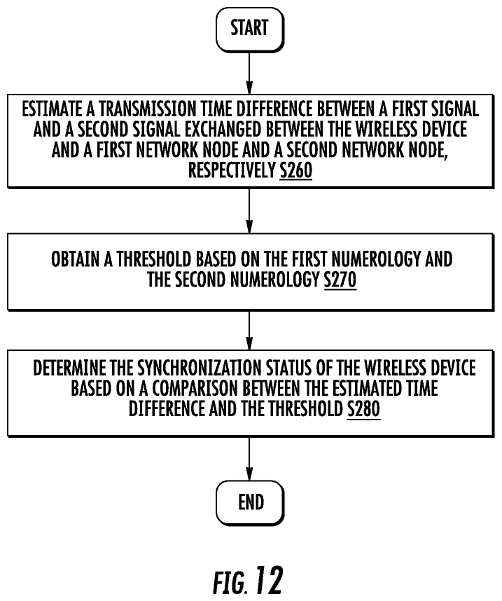

FIG. 12 is a flowchart of an exemplary process performed by a wireless device 20 for determining a synchronization status for the wireless device 20 based on a first numerology and a second numerology defined for data transmission. The process includes estimating a transmission time difference between a first signal and a second signal exchanged between the wireless device 20 and a first network node 34 and a second network node 34, respectively (block S260). The process also includes obtaining a threshold based on the first numerology and the second numerology (block S270). The process further includes determining the synchronization status of the wireless device 20 based on a comparison between the estimated transmission time difference and the threshold (block S280).

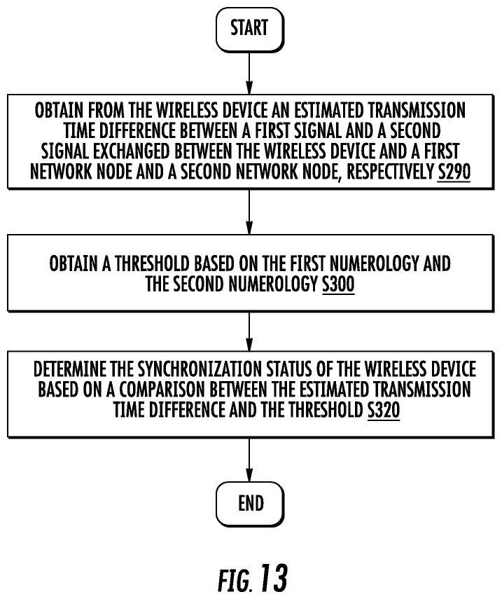

FIG. 13 is a flowchart of an exemplary process performed by a network node 34 for determining a synchronization status for a wireless device. The process includes obtaining, from the wireless device 20, an estimated transmission time difference between a first signal and a second signal exchanged between the wireless device 20 and a first network node 34 and a second network node 34 respectively (block S290). The process also includes obtaining a threshold based on the first numerology and the second numerology (block S300). The process further includes determining the synchronization status of the wireless device 20 based on a comparison between the estimated transmission time difference and the threshold (block S320).

In some embodiments, the first signal is a first downlink signal from the first network node and the second signal is a second downlink signal from the second network node and estimating the transmission time difference comprises estimating a time difference between receipt of the first downlink signal received from the first network node and receipt of the second downlink signal received from the second network node.

In some embodiments, obtaining the threshold comprises obtaining a downlink threshold. In this case, determining the synchronization status comprises determining the synchronization status based on a comparison between the estimated time difference and the downlink threshold. The first signal may be a first uplink signal and the second signal is a second uplink signal and estimating the transmission time difference comprises estimating a time difference between transmitting the first uplink signal to the first network node and transmitting the second uplink signal to the second network node. Obtaining the threshold may include obtaining an uplink threshold. In this case, determining the synchronization status comprises determining the synchronization status based on a comparison between the estimated time difference and the uplink threshold. The first numerology may be used for operating the first downlink signal and the second numerology is used for operating a second downlink signal. The first network node 34 and the second network node 34 may be the same node. Alternatively, the first network node 34 and the second network node 34 may be different nodes. The method may further include indicating to another node, information about capability of the wireless device 20 related to support of at least one of synchronous and asynchronous multi-connectivity. The indication may be sent to the other node in response to receipt of a request from the other node. The method may further include using the determined synchronization status of the wireless device 20 for at least one operational task. The at least one operational task may comprise at least one of demodulation of received signals, transmission of signals, radio measurements, at least one of selection and application of a power control scheme, transmission of at least one of the estimated time difference and an uplink transmit time difference to another wireless device, transmission of at least one of the estimated time difference and the uplink transmit time difference to another network node 34, and indicating the synchronization status of the wireless device 20 to at least one of another network node 34 or another wireless device 20. The downlink threshold may be selected from a table of thresholds corresponding to different subcarrier spacings. In some embodiments, the synchronization status of the wireless device 20 is synchronized when the estimated time difference exceeds the downlink threshold and is asynchronous otherwise. The process may comprise obtaining a second downlink threshold based on the first numerology and the second numerology and determining the synchronization status of the wireless device is based on a comparison between the estimated time difference and the second downlink threshold. The magnitude of the first downlink threshold may decrease with the increase in the subcarrier spacing used in at least one of the first downlink cell and the second downlink cell. The process may comprise obtaining a second uplink threshold based on the first numerology and the second numerology and determining the synchronization status of the wireless device is based on a comparison between the estimated time difference and the second uplink threshold. The magnitude of the second downlink threshold may decrease with the increase in the subcarrier spacing used in at least one of the first downlink cell and the second downlink cell.

According to another aspect, some embodiments include a wireless device 20 configured to determine a synchronization status for the wireless device 20 based on a first numerology and a second numerology. The wireless device 20 includes a communications interface 32. The wireless device also includes processing circuitry 22 configured to perform the process/method of FIG. 12.

In some embodiments, a method performed by a network node 34 for determining a synchronization status for a wireless device 20 based on a first numerology and a second numerology defined for data transmission is provided. The method comprises: obtaining, from the wireless device, an estimated transmission time difference between a first signal and a second signal exchanged between the wireless device and a first network node and a second network node respectively (block S290); obtaining a threshold based on the first numerology and the second numerology (block S300); and determining the synchronization status of the wireless device based on a comparison between the estimated transmission time difference and the threshold (block S320) . . . . The first signal may be a first downlink signal from the first network node and the second signal is a second downlink signal from the second network node and estimating the transmission time difference comprises estimating a time difference between receipt of the first downlink signal received from the first network node and receipt of the second downlink signal received from the second network node. Obtaining the threshold may comprise obtaining a downlink threshold. In this case, the comparison is between the estimated transmission time difference and the downlink threshold. In some embodiments, the first signal is a first uplink signal and the second signal is a second uplink signal and wherein estimating the transmission time difference comprises estimating a time difference between transmitting the first uplink signal to the first network node and transmitting the second uplink signal to the second network node. Obtaining the threshold may comprise obtaining an uplink threshold. In this case, the comparison is between the estimated transmission time difference and the uplink threshold. The process may comprise obtaining a second uplink threshold based on the first numerology and the second numerology and determining the synchronization status of the wireless device is based on a comparison between the estimated transmission time difference and the second uplink threshold, A magnitude of the second uplink threshold may decrease with an increase in subcarrier spacing used in at least one of a first uplink cell and a second uplink cell.

In some embodiments, the first numerology is used for operating the first downlink signal and the second numerology is used for operating the second downlink signal. The first network node 34 and the second network node 34 may be the same node. Alternatively, the first network node 34 and the second network node 34 may be different nodes. In some embodiments, the method further includes obtaining information about capability of the wireless device 20 related to support of at least one of synchronous and asynchronous multi-connectivity. The information may be received from the wireless device 20 in response to a request for the information from the network node 34. The method may further include using the determined synchronization status of the wireless device 20 for at least one operational task. The at least one operational task may include at least one of reception of signal from the wireless device 20, transmission of signals to the wireless device 20, scheduling of at least one of uplink and downlink signals, radio measurements, timing advance estimation, adaptation of configuration of measurement gaps, adaptation of the discontinuous reception, DRX, configuration used for the wireless device, adaptation of measurement configuration sent to the wireless device, configuration of a timing advance group, at least one of selection and configuration of a power control scheme, and transmission of at least one of the estimated time difference and an uplink transmit time difference to another network node 34, A magnitude of the uplink threshold may decrease with an increase in subcarrier spacing used in at least one of a first uplink cell and a second uplink cell. In some embodiments, a network node 34 is configured to perform all the steps of the method of FIG. 13. More specifically, the network node 34 comprises a processing circuitry configured to perform the embodiments and functionalities provided by the methods described herein.

Some embodiments include:

### Embodiment 1

A method performed by a wireless device for determining a synchronization status for the wireless device based on a first numerology and a second numerology, the method comprising:

estimating a time difference between receipt of a first downlink signal received from a first network node, and receipt of a second downlink signal received from a second network node;

obtaining a first downlink threshold based on the first numerology and the second numerology; and

determining the synchronization status of the wireless device based on a relationship between the estimated time difference and the first downlink threshold.

### Embodiment 2

The method of Embodiment 1, wherein the first numerology is used for operating the first downlink signal and the second numerology is used for operating the second downlink signal.

### Embodiment 3

The method of Embodiment 1, wherein the first network node and the second network node are a same node.

### Embodiment 4

The method of Embodiment 1, wherein the first network node and the second network node are different nodes.

### Embodiment 5

The method of Embodiment 1, further comprising indicating to another node, information about capability of the wireless device related to support of at least one of synchronous and asynchronous multi-connectivity.

### Embodiment 6

The method of Embodiment 5, wherein the indication is sent to the other node in response to receipt of a request from the other node.

### Embodiment 7

The method of Embodiment 1, further comprising using the determined synchronization status of the wireless device for at least one operational task.

### Embodiment 8

The method of Embodiment 7, wherein the at least one operational task comprises at least one of demodulation of received signals, transmission of signals, radio measurements, at least one of selection and application of a power control scheme, transmission of at least one of the estimated time difference and an uplink transmit time difference to another wireless device, transmission of at least one of the estimated time difference and the uplink transmit time difference to another network node, and indicating the synchronization status of the wireless device to at least one of another network node or another wireless device.

### Embodiment 9

The method of Embodiment 1, further comprising estimating, at the wireless device, a transmit time difference between a first uplink signal transmitted by the wireless device in a first cell operated by the first network node a second uplink signal transmitted by the wireless device in a second cell operated by the second network node.

### Embodiment 10

A wireless device configured to determine a synchronization status for the wireless device based on a first numerology and a second numerology, the wireless device comprising:

a communications interface; and

processing circuitry including a memory and one or more processors, the memory in communication with the one or more processors, the memory configured to store first signal sequences and second signal sequences, the memory having instructions that, when executed by the one or more processors, configure the one or more processors to:
estimate a time difference between receipt of a first downlink signal received from a first network node, and receipt of a second downlink signal received from a second network node;
obtain a first downlink threshold based on the first numerology and the second numerology; and
determine the synchronization status of the wireless device based on a relationship between the estimated time difference and the first downlink threshold.

### Embodiment 11

The wireless device of Embodiment 10, wherein the first numerology is used for operating the first downlink signal and the second numerology is used for operating the second downlink signal.

### Embodiment 12

The wireless device of Embodiment 10, wherein the first network node and the second network node are a same node.

### Embodiment 13

The wireless device of Embodiment 10, wherein the first network node and the second network node are different nodes.

### Embodiment 14

The wireless device of Embodiment 10, wherein the communications interface is configured to indicate to another node, information about capability of the wireless device related to support of at least one of synchronous and asynchronous multi-connectivity.

### Embodiment 15

The wireless device of Embodiment 14, wherein the indication is sent to the other node in response to receipt of a request from the other node.

### Embodiment 16

The wireless device of Embodiment 10, wherein the one or more processors is further configured to use the determined synchronization status of the wireless device for at least one operational task.

### Embodiment 17

The wireless device of Embodiment 16, wherein the at least one operational task comprises at least one of demodulation of received signals, transmission of signals, radio measurements, at least one of selection and application of a power control scheme, transmission of at least one of the estimated time difference and an uplink transmit time difference to another wireless device, transmission of at least one of the estimated time difference and the uplink transmit time difference to another network node, and indicating the synchronization status of the wireless device to at least one of another network node or another wireless device.

### Embodiment 18

The wireless device of Embodiment 10, wherein the one or more processors is further configured to estimate a transmit time difference between a first uplink signal transmitted by the wireless device in a first cell operated by the first network node a second uplink signal transmitted by the wireless device in a second cell operated by the second network node.

### Embodiment 19

A method performed by a network node for determining a synchronization status for a wireless device based on a first numerology and a second numerology, the method comprising:

obtaining, from the wireless device, an estimated time difference between receipt, by the wireless device of a first downlink signal received from a first network node, and receipt, by the wireless device of a second downlink signal received from a second network node;

obtaining a first downlink threshold based on the first numerology and the second numerology; and

determining the synchronization status of the wireless device based on a relationship between the estimated time difference and the first downlink threshold.

### Embodiment 20

The method of Embodiment 19, wherein the first numerology is used for operating the first downlink signal and the second numerology is used for operating the second downlink signal.

### Embodiment 21

The method of Embodiment 19, wherein the first network node and the second network node are a same node.

### Embodiment 22

The method of Embodiment 19, wherein the first network node and the second network node are different nodes.

### Embodiment 23

The method of Embodiment 19, further comprising obtaining information about capability of the wireless device related to support of at least one of synchronous and asynchronous multi-connectivity.

### Embodiment 24

The method of Embodiment 23, wherein the information is received from the wireless device in response to a request for the information from the network node.

### Embodiment 25

The method of Embodiment 19, further comprising using the determined synchronization status of the wireless device for at least one operational task.

### Embodiment 26

The method of Embodiment 25, wherein the at least one operational task comprises at least one of reception of signal from the wireless device, transmission of signals to the wireless device, scheduling of at least one of uplink and downlink signals, radio measurements, timing advance estimation, adaptation of configuration of measurement gaps, adaptation of the discontinuous reception, DRX, configuration used for the wireless device, adaptation of measurement configuration sent to the wireless device, configuration of a timing advance group, at least one of selection and configuration of a power control scheme, and transmission of at least one of the estimated time difference and an uplink transmit time difference to another network node.

### Embodiment 27

The method of Embodiment 19, further comprising obtaining, at the network node, a transmit time difference, estimated by the wireless device, between a first uplink signal transmitted by the wireless device in a first cell a second uplink signal transmitted by the wireless device in a second cell.

### Embodiment 28

A network node configured to determine a synchronization status for a wireless device based on a first numerology and a second numerology, the network node comprising:

a communications interface configured to:
obtain, from the wireless device, an estimated time difference between receipt, by the wireless device of a first downlink signal received from a first network node, and receipt, by the wireless device of a second downlink signal received from a second network node;
obtain a first downlink threshold based on the first numerology and the second numerology; and

processing circuitry including a memory and one or more processors, the memory in communication with the one or more processors, the memory configured to store first signal sequences and second signal sequences, the memory having instructions that, when executed by the one or more processors, configure the one or more processors to:
determine the synchronization status of the wireless device based on a relationship between the estimated time difference and the first downlink threshold.

### Embodiment 29

The network node of Embodiment 28, wherein the first numerology is used for operating the first downlink signal and the second numerology is used for operating the second downlink signal.

### Embodiment 30

The network node of Embodiment 28, wherein the first network node and the second network node are the same.

### Embodiment 31

The network node of Embodiment 28, wherein the first network node and the second network node are different.

### Embodiment 32

The network node of Embodiment 28, wherein the communications interface is further configured to obtain information about capability of the wireless device related to support of at least one of synchronous and asynchronous multi-connectivity.

### Embodiment 33

The network node of Embodiment 32, wherein the information is received from the wireless device in response to a request for the information from the network node.

### Embodiment 34

The network node of Embodiment 28, wherein the one or more processors is further configured to use the determined synchronization status of the wireless device for at least one operational task.

### Embodiment 35

The network node of Embodiment 34, wherein the at least one operational task comprises at least one of reception of signal from the wireless device, transmission of signals to the wireless device, scheduling of at least one of uplink and downlink signals, radio measurements, timing advance estimation, adaptation of configuration of measurement gaps, adaptation of the discontinuous reception, DRX, configuration used for the wireless device, adaptation of measurement configuration sent to the wireless device, configuration of a timing advance group, at least one of selection and configuration of a power control scheme, and transmission of at least one of the estimated time difference and an uplink transmit time difference to another network node.

### Embodiment 36

The network node of Embodiment 28, wherein the communications interface is further configured to obtain a transmit time difference, estimated by the wireless device, between a first uplink signal transmitted by the wireless device in a first cell a second uplink signal transmitted by the wireless device in a second cell.

### Embodiment 37

A wireless device configured to determine a synchronization status for the wireless device based on a first numerology and a second numerology, the wireless device comprising:

a memory module;

a time difference estimation module configured to estimate a time difference between receipt of a first downlink signal received from a first network node, and receipt of a second downlink signal received from a second network node; and

a synchronization status determination module configured to:
obtain a first downlink threshold based on the first numerology and the second numerology; and
determine the synchronization status of the wireless device based on a relationship between the estimated time difference and the first downlink threshold.

### Embodiment 38

A network node configured to determine a synchronization status for a wireless device based on a first numerology and a second numerology, the network node comprising:

a communications interface module configured to:
obtain, from the wireless device, an estimated time difference between receipt, by the wireless device of a first downlink signal received from a first network node, and receipt, by the wireless device of a second downlink signal received from a second network node; and
obtain a first downlink threshold based on the first numerology and the second numerology; and

a synchronization status determination module configured to determine the synchronization status of the wireless device based on a relationship between the estimated time difference and the first downlink threshold.

As will be appreciated by one of skill in the art, the concepts described herein may be embodied as a method, data processing system, and/or computer program product. Accordingly, the concepts described herein may take the form of an entirely hardware embodiment, an entirely software embodiment or an embodiment combining software and hardware aspects all generally referred to herein as a “circuit” or “module.” Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to one or more processors of a general purpose computer (to thereby create a special purpose computer), special purpose computer, or other programmable data processing apparatus to produce a machine, such that the instructions, which execute via the one or more processors of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings, which are limited only by the scope of the claims.

1-13. (canceled)

14. A wireless device configured to determine a synchronization status for the wireless device based on a first numerology and a second numerology, the wireless device comprising:
a communications interface; and
processing circuitry configured to:
estimate a time difference between receipt of a first downlink signal received from a first network node, and receipt of a second downlink signal received from a second network node, the first numerology being used for operating the first downlink signal and the second numerology being used for operating the second downlink signal;
obtain a downlink threshold based on the first numerology and the second numerology; and
determine the synchronization status of the wireless device based on a comparison between the estimated time difference and the downlink threshold.

15. The wireless device of claim 14, wherein the first numerology is used for operating the first downlink signal and the second numerology is used for operating the second downlink signal.

16. The wireless device of claim 14, wherein the first network node and the second network node are a same node.

17. (canceled)

18. The wireless device of claim 14, wherein the communications interface is configured to indicate to another node, information about capability of the wireless device related to support of at least one of synchronous and asynchronous multi-connectivity.

19. (canceled)

20. The wireless device of claim 14, wherein the one or more processors is further configured to use the determined synchronization status of the wireless device for at least one operational task, wherein the at least one operational task comprises at least one of demodulation of received signals, transmission of signals, radio measurements, at least one of selection and application of a power control scheme, transmission of at least one of the estimated time difference and an uplink transmit time difference to another wireless device, transmission of at least one of the estimated time difference and the uplink transmit time difference to another network node, and indicating the synchronization status of the wireless device to at least one of another network node or another wireless device.

21. (canceled)

22. The wireless device of claim 14, wherein the one or more processors is further configured to estimate a transmit time difference between a first uplink signal transmitted by the wireless device in a first cell operated by the first network node and a second uplink signal transmitted by the wireless device in a second cell operated by the second network node.

23. The wireless device of claim 14, wherein the downlink threshold is selected from a table of thresholds corresponding to different subcarrier spacings.

24. The wireless device of claim 14, wherein the synchronization status of the wireless device is synchronized when the estimated time difference exceeds the downlink threshold and is asynchronous otherwise.

25. The wireless device of claim 14, wherein a magnitude of the downlink threshold decreases with an increase in subcarrier spacing used in at least one of a first downlink cell and a second downlink cell.

26. The wireless device of claim 14, wherein a magnitude of a second downlink threshold decreases with an increase in subcarrier spacing used in at least one of a first downlink cell and a second downlink cell.

27-35. (canceled)

36. A network node configured to determine a synchronization status for a wireless device based on a first numerology and a second numerology, the network node comprising:
a communications interface configured to:
obtain, from the wireless device, an estimated time difference between receipt, by the wireless device of a first downlink signal received from a first network node, and receipt, by the wireless device of a second downlink signal received from a second network node, the first numerology being used for operating the first downlink signal and the second numerology being used for operating the second downlink signal;
obtain a downlink threshold based on the first numerology and the second numerology; and
processing circuitry configured to:
determine the synchronization status of the wireless device based on a comparison between the estimated time difference and the downlink threshold.

37. The network node of claim 36, wherein the first numerology is used for operating the first downlink signal and the second numerology is used for operating the second downlink signal.

38. The network node of claim 36, wherein the first network node and the second network node are a same node.

39. (canceled)

40. The network node of claim 36, wherein the communications interface is further configured to obtain information about capability of the wireless device related to support of at least one of synchronous and asynchronous multi-connectivity.

41. (canceled)

42. The network node of claim 36, wherein the processing circuitry is further configured to use the determined synchronization status of the wireless device for at least one operational task, wherein the at least one operational task comprises at least one of reception of signal from the wireless device, transmission of signals to the wireless device, scheduling of at least one of uplink and downlink signals, radio measurements, timing advance estimation, adaptation of configuration of measurement gaps, adaptation of the discontinuous reception, DRX, configuration used for the wireless device, adaptation of measurement configuration sent to the wireless device, configuration of a timing advance group, at least one of selection and configuration of a power control scheme, and transmission of at least one of the estimated time difference and an uplink transmit time difference to another network node.

43. (canceled)

44. The network node of claim 36, wherein the communications interface is further configured to obtain a transmit time difference, estimated by the wireless device, between a first uplink signal transmitted by the wireless device in a first cell and a second uplink signal transmitted by the wireless device in a second cell.

45-50. (canceled)

51. A wireless device configured to determine a synchronization status for the wireless device based on a first numerology and a second numerology, the wireless device comprising:
processing circuitry configured to:
estimate a time difference between transmission of a first uplink signal transmitted by the wireless device and transmission of a second uplink signal transmitted by the wireless device, the first numerology being used for operating the first uplink signal and the second numerology being used for operating the second uplink signal;
obtain an uplink threshold based on the first numerology and the second numerology; and
determine the synchronization status of the wireless device based on a comparison between the estimated time difference and the uplink threshold.

52. The wireless device of claim 51, wherein the first numerology is used for operating the first uplink signal and the second numerology is used for operating the second uplink signal.

53. The wireless device of claim 51, wherein the first network node and the second network node are a same node.

54-60. (canceled)

61. A network node configured to determine a synchronization status for a wireless device based on a first numerology and a second numerology, the network node comprising:
processing circuitry configured to:
obtain, from the wireless device, an estimated time difference between transmission of a first uplink signal and transmission of a second uplink signal, the first numerology being used for operating the first uplink signal and the second numerology being used for operating the second uplink signal;
obtain an uplink threshold based on the first numerology and the second numerology; and
determine the synchronization status of the wireless device based on a comparison between the estimated time difference and the uplink threshold.

62. The network node of claim 61, wherein the first numerology is used for operating the first uplink signal and the second numerology is used for operating the second uplink signal.

63. The network node of claim 61, wherein the first network node and the second network node are a same node.

64-69. (canceled)

70. A wireless device for determining a synchronization status for the wireless device based on a first numerology and a second numerology defined for data transmission, the wireless device comprising:
processing circuitry configured to:
estimate a transmission time difference between a first signal and a second signal exchanged between the wireless device and a first network node and a second network node, respectively, the first numerology being used for operating the first signal and the second numerology being used for operating the second signal;
obtain a threshold based on the first numerology and the second numerology; and
determine the synchronization status of the wireless device based on a comparison between the estimated transmission time difference and the threshold.

71. The wireless device of claim 70, wherein the first signal is a first downlink signal from the first network node and the second signal is a second downlink signal from the second network node and wherein estimating the transmission time difference comprises estimating a time difference between receipt of the first downlink signal received from the first network node and receipt of the second downlink signal received from the second network node, and wherein obtaining the threshold comprises obtaining a downlink threshold.

72. (canceled)

73. The wireless device of claim 70, wherein the first signal is a first uplink signal and the second signal is a second uplink signal and wherein estimating the transmission time difference comprises estimating a time difference between transmitting the first uplink signal to the first network node and transmitting the second uplink signal to the second network node, and wherein obtaining the threshold comprises obtaining an uplink threshold.

74-84. (canceled)
